(19) United States
(12) Patent Application Publication
(10) Pub. No.: US 2017/0234039 A1
(43) Pub. Date: Aug. 17, 2017

(54) VEHICLE DOOR LATCH DEVICE

(71) Applicant: MITSUI KINZOKU ACT CORPORATION, Yokohama-shi, Kanagawa (JP)

(72) Inventor: Takao TAGA, Kanagawa (JP)

(21) Appl. No.: 15/503,897

(22) PCT Filed: Dec. 24, 2014
(86) PCT No.: PCT/JP2014/084148

§ 371 Date: Feb. 14, 2017

(30) Foreign Application Priority Data
Sep. 8, 2014 (JP) 2014-182441

(51) Int. Cl. E05B 79/04; E05B 85/02

(52) U.S. Cl. CPC E05B 79/04; E05B 85/02

(57) ABSTRACT

A vehicle door latch device includes: a body including a striker advancing groove; a cover plate including: a striker advancing groove; and a bent portion at a side portion opposite to an inlet of the striker advancing groove and bent substantially perpendicularly towards the body; at least one female screw hole provided closer to a side end portion of the cover plate, the side end portion opposite to the bent portion, at any one of both sides sandwiching the striker advancing groove; at least two female screw holes provided separately from each other in a direction in which the striker advances, at the other one of the both sides sandwiching the same striker advancing groove; and at least two positioning holes for positioning the cover plate are respectively provided near the one female screw hole and between the two female screw holes in the cover plate.

### FIELD

The present invention relates to a vehicle door latch device.

### BACKGROUND

Conventional vehicle door latch devices include a vehicle door latch device having an engagement unit (an engagement unit assembly) including: a body with an open surface, the body accommodating therein an engagement mechanism, such as a latch and a ratchet engageable with this latch, and the body made of synthetic resin; a cover plate that closes the opening of the body and is made of metal; a back plate that is fixed to a reverse surface of the body and is made of metal; and the like (see Patent Literature 1, for example).

In this door latch device, for fixing the engagement unit to an inner panel of a door with plural bolts, plural (three) bolt insertion holes are provided in the cover plate, and plural female screw holes, into which the bolts inserted through the bolt insertion holes are screwed, are provided in the back plate, respectively.

When plural female screw holes, into which bolts are screwed, are provided in a back plate, which is made of metal, like in the door latch device described in Patent Literature 1, since a region where the female screw holes are to be formed needs to be provided in the back plate, there is a problem that the back plate becomes unnecessarily large, the door latch device is upsized, and thus mass of the door latch device is increased.

In Patent Literature 2, a door latch device is described, in which plural female screw holes are provided on a cover plate (base plate) side in order to achieve downsizing and weight reduction of the back plate (sub base plate).

### CITATION LIST

### Patent Literature

Patent Literature 1: Japanese Patent No. 4765123

Patent Literature 2: Japanese Patent Application Laid-open No. 2013-130028

### SUMMARY

### Technical Problem

A door latch device, which is provided with plural female screw holes on a cover plate side thereof, like the door latch device described in the above cited Patent Literature 2, has the following problems.

In recent years, in order to improve assembly efficiency of door latch devices, engagement units have often been assembled automatically in automatic assembly lines and the like, for example. In that case, in a cover plate fixed in a fixed position by a positioning tool, various parts, such as a latch shaft, a latch, a ratchet, a body, and a back plate, are sequentially installed. In this positioning of the cover plate, like the door latch device described in Patent Literature 1, for example, plural bolt insertion holes provided in the cover plate are used.

However, in the door latch device described in Patent Literature 2, when the bolt insertion holes are modified into the female screw holes and projecting portions of the positioning tool are inserted in the female screw holes, there will be a risk that the female screws will be damaged, and thus the female screw holes are unable to be used as positioning holes. Therefore, positioning holes need to be specially provided in the cover plate. Like in the door latch device described in Patent Literature 2, for example, when the positioning holes are provided in a cover plate, in which a bent portion is formed at an end portion of the cover plate in order to improve strength thereof, the end portion on an extra-vehicle side and the bent portion bent in an L-shape towards the body, there is a risk that, depending on positions of the positioning holes, the positioning holes may be deformed when the bent portion is formed by press working, and the projecting portions of the positioning tool may then be uninsertable in the positioning holes.

In view of the above described problems, an object of the present invention is to provide a vehicle door latch device, which is able to prevent a positioning tool from being uninsertable in a positioning hole provided in a cover plate.

### Solution to Problem

To solve the problem and achieve the object, a vehicle door latch device according to the present invention includes: a body configured to accommodate therein an engagement mechanism adapted to restrain a door in a closed position, the body including a striker advancing groove, into which a striker is able to advance; and a cover plate made of metal and configured to close a surface of the body, the cover plate including: a striker advancing groove having a shape that is substantially the same as a shape of the striker advancing groove of the body; and a bent portion at a side portion opposite to an inlet of the striker advancing groove and bent substantially perpendicularly towards the body; wherein at least one female screw hole, into which a bolt for fixing the door is screwable, is provided closer to a side end portion of the cover plate, the side end portion opposite to the bent portion, at any one of both sides sandwiching the striker advancing groove in the cover plate; at least two female screw holes, into which bolts for fixing the door are screwable, are provided separately from each other in a direction in which the striker advances, at the other one of the both sides sandwiching the same striker advancing groove; and positioning holes, for positioning the cover plate when various parts of the engagement mechanism are installed in the cover plate, are respectively provided near the one female screw hole and between the two female screw holes in the cover plate.

Moreover, in the vehicle door latch device according to the present invention, any one of the positioning holes is a circular hole, and the other one thereof is a long hole that is long in a direction of a straight line joining centers of the positioning holes.

Moreover, in the vehicle door latch device according to the present invention, a minor axis direction dimension of the positioning hole that is the long hole is the same as a diameter of the circular hole.

### Advantageous Effects of Invention

According to the present invention, by provision of plural positioning holes at positions in a cover plate, the positions separated from a bent portion provided at a side edge opposite to an inlet of a striker advancing groove in the cover plate, the positioning holes will not be deformed when the bent portion is bent by press working after the positioning holes are drilled, and projecting portions of a positioning tool will not be uninsertable in the positioning holes.

### BRIEF DESCRIPTION OF DRAWINGS

FIG. 1 is a perspective view of a door latch device according to the present invention and a door, in which the door latch device is installed, the door latch device and the door as obliquely viewed from the rear on an intra-vehicle side.

FIG. 2 is a rear view of the door latch device before an engagement unit is integrated with an operation unit.

FIG. 3 is a rear view of the door latch device after the engagement unit is integrated with the operation unit.

FIG. 4 is a perspective view of the same door latch device as obliquely viewed from the rear.

FIG. 5 is a perspective view, as viewed from the intra-vehicle side, of an auxiliary cover and a lower portion of the door latch device before installation of the auxiliary cover.

FIG. 6 is a side view of the door latch device in a state where the auxiliary cover has been attached to a cover, the door latch device as viewed from the intra-vehicle side.

FIG. 7 is a side view of the door latch device in a state where the same auxiliary cover has been closed, the door latch device as viewed from the intra-vehicle side.

FIG. 8 is a front view of the engagement unit as viewed from the front.

FIG. 9 is a perspective view of a casing and a body, as viewed from the rear.

FIG. 10 is an enlarged cross sectional view along a line X-X in FIG. 7.

FIG. 11 is an enlarged cross sectional view along a line XI-XI in FIG. 1.

### DESCRIPTION OF EMBODIMENTS

Hereinafter, an embodiment of the present invention will be described, based on the drawings.

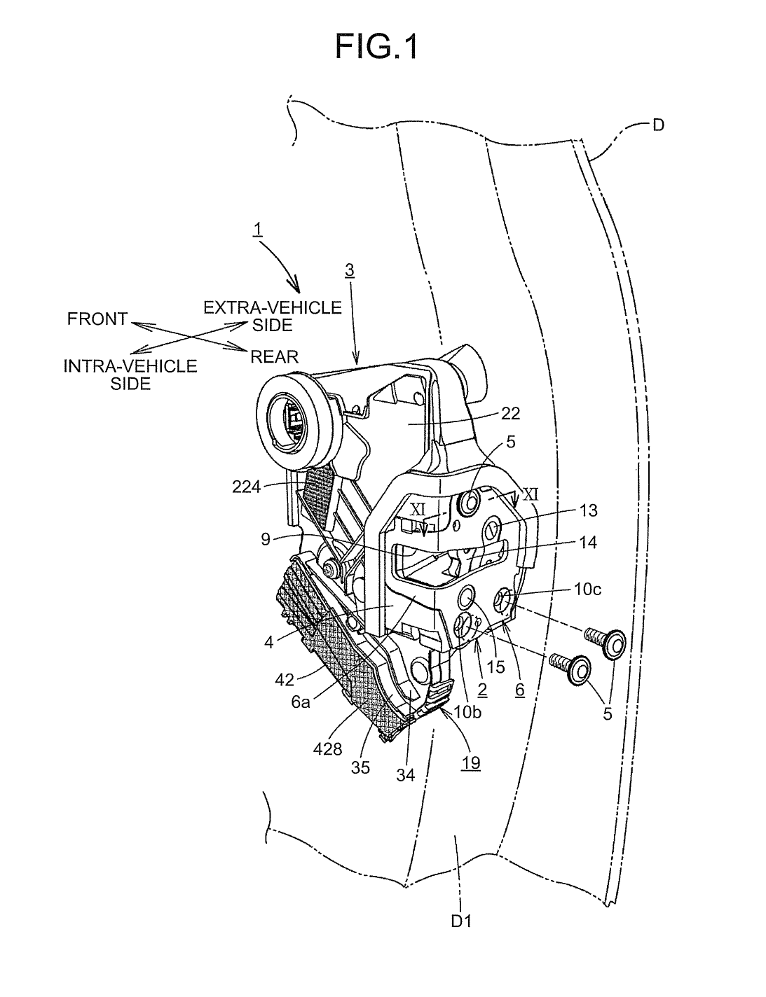

As illustrated in FIG. 1 to FIG. 4, a door latch device 1 according to the present invention: is fixed, in a front door (hereinafter, abbreviated as “door”) D on a right side of a vehicle, for example, to a rear end portion of an inner panel D1 of the door D; and includes an engagement unit 2 for holding the door D in a closed state, and an operation unit 3 for operating this engagement unit 2. The engagement unit 2 and the operation unit 3 are formed by being integrated with each other.

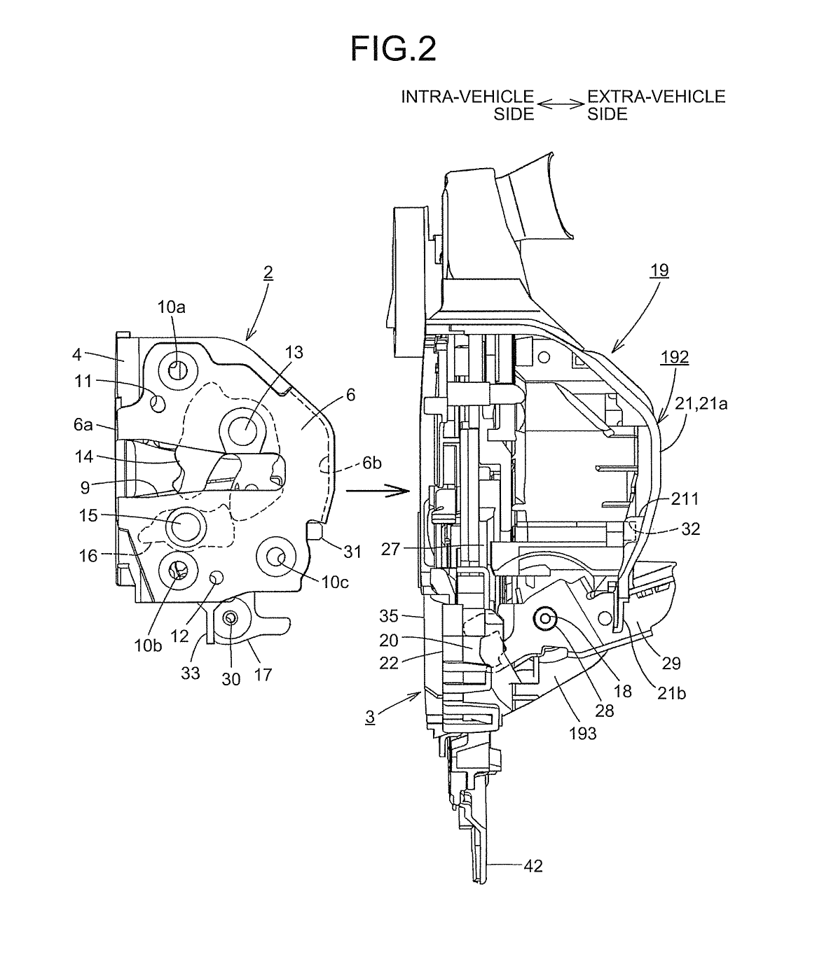

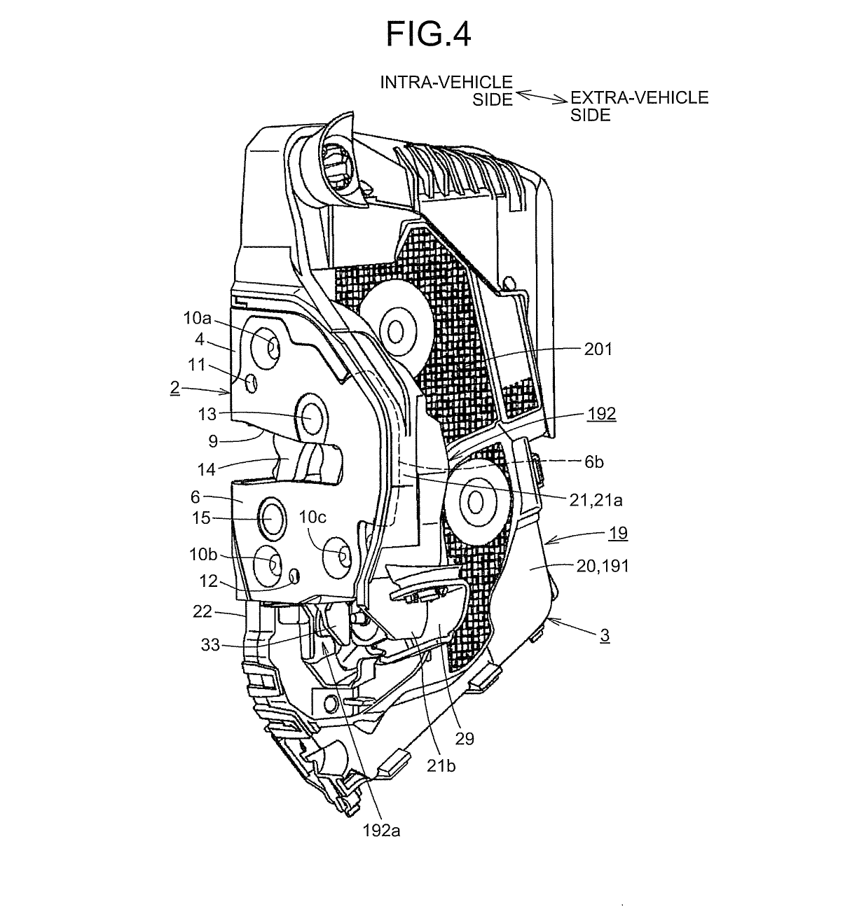

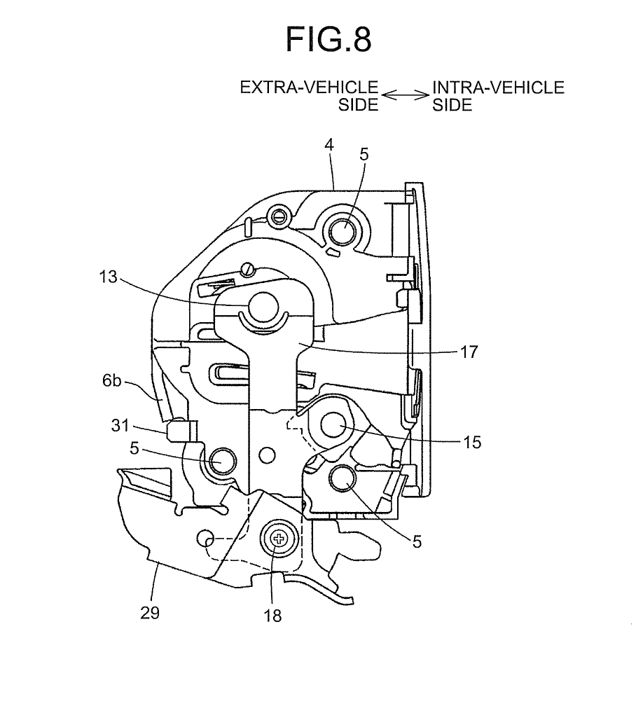

The engagement unit 2 has: a body 4, which is made of synthetic resin and is box shaped; and a cover plate 6, which is fixed to a rear surface of the body 4, fixed, together with the body 4, to a rear portion of the inner panel D1 in the door D by three bolts 5, and is made of metal. In an internal space between the body 4 and the cover plate 6, an engagement mechanism 8, which restrains the door in the closed state, is accommodated. At an up-down direction intermediate portion of a side edge of the cover plate 6, the side edge on an intra-vehicle side, an inner bent portion 6a is formed, which is bent substantially perpendicularly forward (towards the body 4), and which abuts against a side surface of the body 4, the side surface on the intra-vehicle side (see FIG. 1). Further, at an up-down direction intermediate portion of a side edge of the cover plate 6, the side edge on an extra-vehicle side opposite to an inlet of a striker advancing groove 9, an outer bent portion 6b is formed. The outer bent portion 6b of the cover plate 6: is bent substantially perpendicularly forward (towards the body 4); and is a portion, which abuts against a side surface of the body 4, the side surface on the extra-vehicle side, and has a short dimension (see FIG. 2, FIG. 4, and FIG. 8). The inner bent portion 6a may be omitted so that the cover plate 6 has only the outer bent portion 6b. In each of the body 4 and cover plate 6, the striker advancing groove 9, into which a striker 7 advances in response to the door D being closed, is formed. Shapes of the striker advancing groove 9 in the body 4 and cover plate 6 are substantially the same.

One female screw hole 10a is formed forward above the striker advancing groove 9 in the cover plate 6, and two female screw holes 10b and 10c are formed forward below the striker advancing groove 9 in the cover plate 6, respectively by burring. The female screw holes 10a and 10b are provided at positions separated from a rotational region of a latch 14 and a ratchet 16, which will be described later, forming the engagement mechanism 8, such that the bolts 5 screwed into these female screw holes 10a and 10b do not interfere with the latch 14 and ratchet 16. That is, the upper female screw hole 10a is provided to be positioned closer to a side end portion of the cover plate 6, the side end portion on the intra-vehicle side opposite to the outer bent portion 6b. The lower two female screw holes 10b and 10c are provided separately from each other, along an advancing direction of the striker 7, and near both end portions of a lower end portion of the cover plate 6, the end portions on the intra-vehicle side and extra-vehicle side. By the bolts 5 being screwed into these respective female screw holes 10a, 10b, and 10c, the engagement unit 2 is fixed to the inner panel D1 (see FIG. 1).

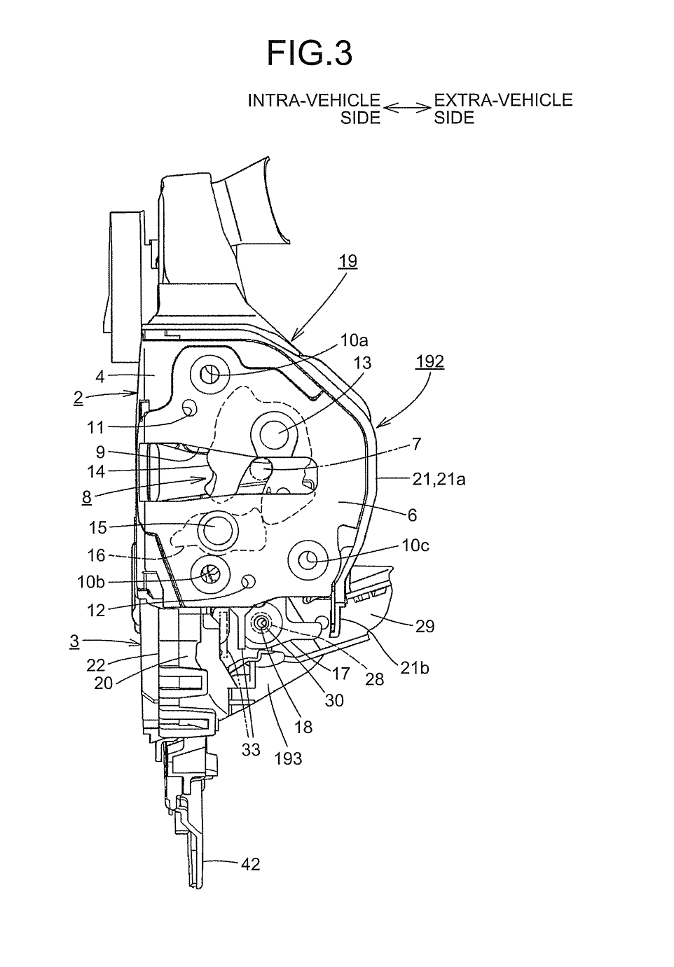

As illustrated in FIG. 2 and FIG. 3, in an upper portion and a lower portion of the cover plate 6, the upper portion and lower portion sandwiching the striker advancing groove 9, a positioning hole 11, which is a long hole, and a positioning hole 12, which is a circular hole, are respectively drilled. The upper positioning hole 11 is provided, near and obliquely below the upper female screw hole 10a and closer to the side end portion of the cover plate 6, the side end portion on the intra-vehicle side, and the lower positioning hole 12 is provided near the female screw hole 10b on the intra-vehicle side, between the lower two female screw holes 10b and 10c, respectively. Further, a major axis direction of the upper positioning hole 11, which is a long hole, is the same as a direction of a straight line joining the centers of both the positioning holes 11 and 12, and a minor axis direction dimension of the upper positioning hole 11 is the same as a diameter of the lower positioning hole 12, such that projecting portions for positioning of the same dimension are able to be inserted in the upper and lower positioning holes 11 and 12. Sizes of the positioning holes 11 and 12 are made as small as possible such that strength of the cover plate 6 is not reduced. A position of the upper positioning hole 11 may, for example, be provided near the upper female screw hole 10a and closer to the extra-vehicle side, or near an indoor-outdoor direction central portion of the cover plate 6. Furthermore, the upper positioning hole 11 may be a circular hole and the lower positioning hole 12 may be a long hole, oppositely to this embodiment.

The upper and lower positioning holes 11 and 12 are used in positioning and fixing the cover plate 6 by use of a positioning tool, when the engagement unit 2 is automatically assembled in an automatic assembly line, or the like. That is, this positioning is generally carried out by use of three bolt insertion holes provided in the cover plate 6, but if the female screw holes 10a, 10b, and 10c are formed in these bolt insertion holes as described above, when projecting portions of the positioning tool are fitted into the female screw holes 10a, 10b, and 10c, there is a risk that females screws of the female screw holes 10a, 10b, and 10c may be damaged. Therefore, the above described positioning holes 11 and 12 are provided specially. The upper positioning hole 11 is made into the long hole in order to make the projecting portion of the positioning tool fitted in this positioning hole 11 easy to be inserted into and removed from the positioning hole 11. Further, the major axis direction of the positioning hole 11 is in the direction of the straight line joining the centers of both of the positioning holes 11 and 12, in order to prevent the cover plate 6 from rotating about the lower positioning hole 12 and being displaced when the projecting portions for positioning, the projecting portions having the same outer diameter, are inserted in the upper and lower positioning holes 11 and 12.

The upper positioning hole 11 is provided closer to the side end portion of the cover plate 6, the side end portion on the intra-vehicle side. The lower positioning hole 12 is provided between the lower two female screw holes 10b and 10c. Since both of the positioning holes 11 and 12 are largely separated from the outer bent portion 6b of the cover plate 6 as described above, when the outer bent portion 6b is bent by press working after the positioning holes 11 and 12 have been drilled, the positioning holes 11 and 12 will not be deformed, and there will be no risk that the projecting portions of the positioning tool will be uninsertable thereinto. The inner bent portion 6a has the striker advancing groove 9 formed therein, and has bending rigidity smaller than that of the outer bent portion 6b when the outer bent portion 6b is bent by press working. As a result, the inner bent portion 6a is able to be bent easily by press working. Therefore, even if the upper positioning hole 11 is provided at a position near the inner bent portion 6a, the positioning hole 11 will not be deformed.

The engagement mechanism 8 has the latch 14 and the ratchet 16. The latch 14 is pivotably supported in the body 4 by a pivot shaft 13, is biased in an opening direction (clockwise in FIG. 2) by a spring not illustrated, and is engageable with the striker 7 on a vehicle body side. The ratchet 16 is pivotably supported in the body 4 by a pivot shaft 15 and is engageable with an outer peripheral edge of the latch 14. When the door D is closed, the door D is held in a closed state, by the striker 7 engaging with the latch 14, and the ratchet 16 engaging with the outer peripheral edge of the latch 14 and blocking rotation of the latch 14 in the opening direction.

Further, when a locking lever 24 of the operation unit 3 is in an unlocked position and an outside lever 29 or an inside lever 26 is rotated based on an opening operation of an outside handle provided on the extra-vehicle side of the door D, or of an inside handle provided on the intra-vehicle side of the door D (both of which illustration is omitted), the ratchet 16 engaged with the outer peripheral edge of the latch 14 is release actuated and rotated in a releasing direction by an opening lever 27 linked with the outside lever 29, and thereby, the door D becomes openable.

As illustrated in FIG. 8, front end portions of the pivot shafts 13 and 15 penetrate through the body 4, and are fixed, by caulking, to a back plate 17, which is: fixed to a front surface (reverse surface) of the body 4; directed in an up-down direction; and made of metal. Thereby, the body 4 is rigidly sandwiched by the cover plate 6 and the back plate 17. A lower end portion of the back plate 17, the lower end portion protruding downward from a lower end of the body 4, is fixed by a bolt 18 inserted from a front surface side of a second casing 192 in a later described casing 19, to a rear surface lower portion of the second casing 192.

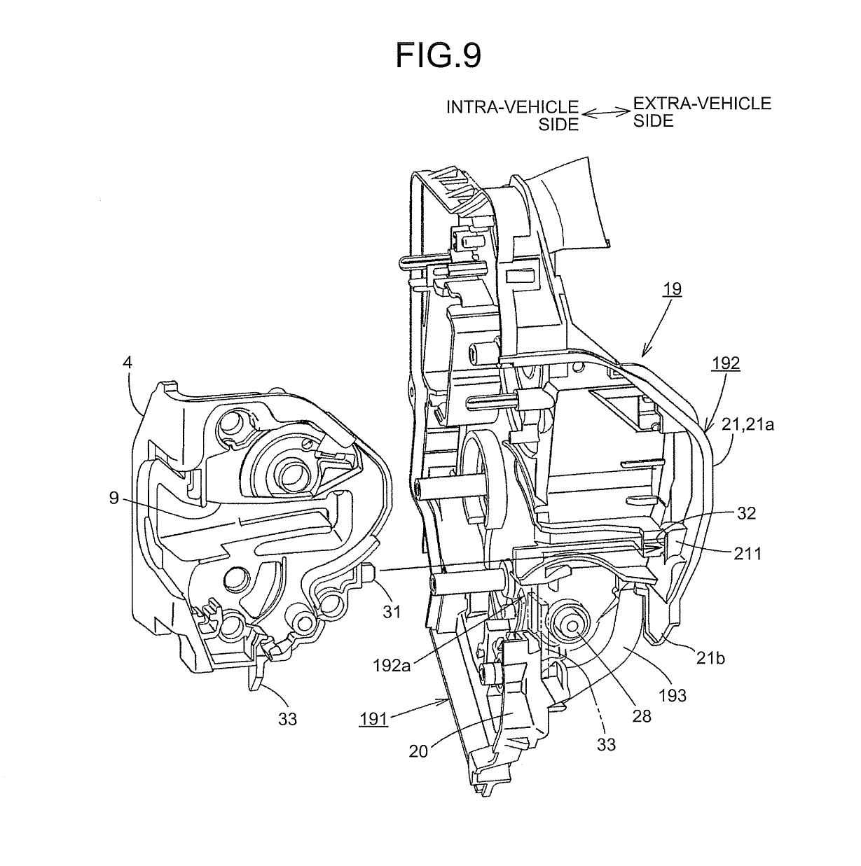

The operation unit 3 includes the casing 19, which is substantially L-shaped in a plan view thereof, and which is made of synthetic resin (see FIG. 9). The casing 19 includes a first casing 191 made of synthetic resin, the second casing 192 made of synthetic resin, and a cover 22 made of synthetic resin. The first casing 191 is arranged adjacent to a side surface of the inner panel D1 in the door D, the side surface on the intra-vehicle side, and has an operation mechanism accommodating portion 20 with an intra-vehicle side that is open. The second casing 192 extends substantially perpendicularly to an outdoor direction from a rear end portion of an up-down direction intermediate portion in the first casing 191, and has a body accommodating portion 21 with a rear surface side that is open. The cover 22 closes an opening of the operation mechanism accommodating portion 20 of the first casing 191, with the vicinity of the striker advancing groove 9 of the body 4 in the engagement unit 2 being exposed. The casing 19 and the cover 22 are molded of, for example, polyacetal resin (POM). As illustrated in FIG. 4, on a side surface of the operation mechanism accommodating portion 20 in the first casing 191, the side surface on the extra-vehicle side, meshed protruding strips 201 are formed, which are for preventing slippage when the door latch device 1 is held and installed in the door D. Further, as illustrated in FIG. 1, on a top portion on a side surface of the cover 22, the side surface on the intra-vehicle side, meshed protruding strips 224 are formed, which are for preventing slippage.

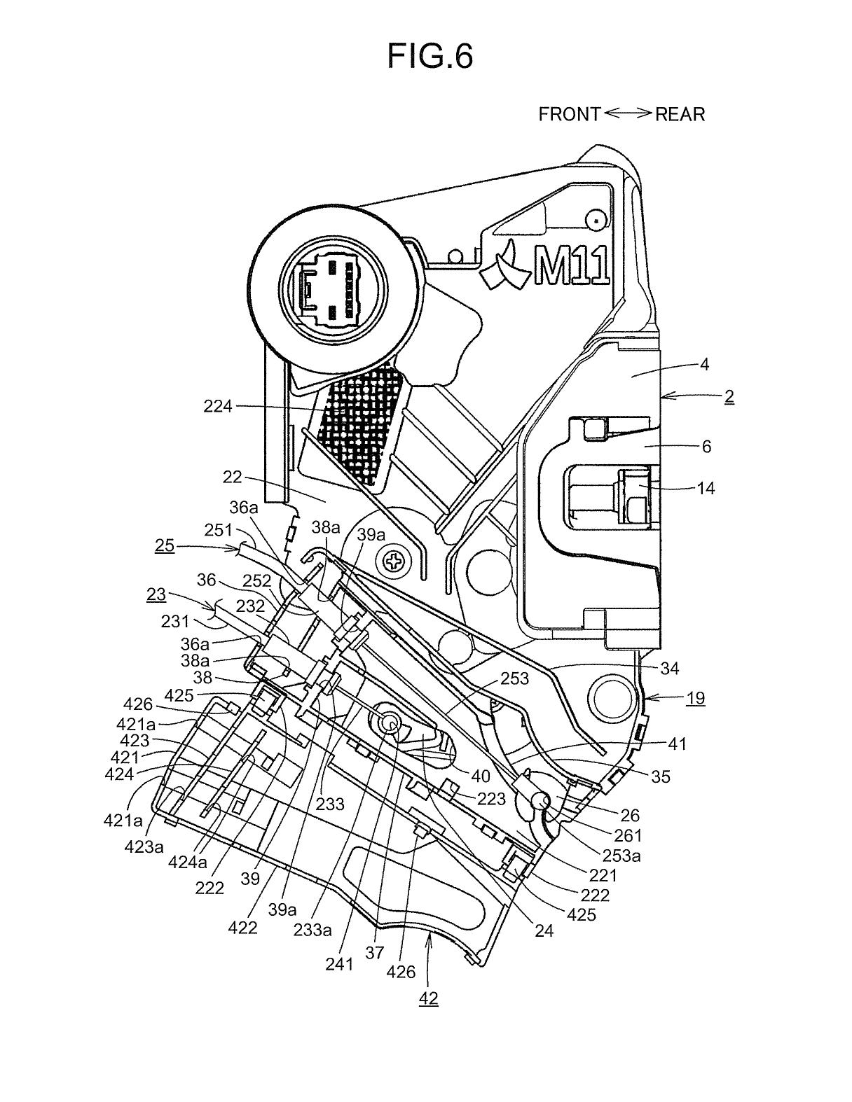

In an accommodating space formed between the cover 22 and the operation mechanism accommodating portion 20 of the first casing 191, an operation mechanism is accommodated. By operating the engagement mechanism 8 of the engagement unit 2, the operation mechanism is able to switch over the engagement mechanism 8 between an unlocked state where an engaged state thereof with the striker 7 is releasable and a locked state where the engaged state is unreleasable, and the operation mechanism is formed of: an actuator (illustration thereof omitted) including a motor that automatically performs locking and unlocking operation; a key lever that moves in association with operation of a key cylinder (illustration of these omitted); the locking lever 24; the inside lever 26; the opening lever 27 (see FIG. 2); and the like. The locking lever 24: is linked, via a first Bowden cable 23 (see FIG. 6), which is an operation force transmitting member, with a locking knob (illustration thereof omitted) provided on the intra-vehicle side of the door D; is actuated by an operation on the locking knob or by the actuator to a locked position and the unlocked position; and forms a part of a locking and unlocking means. The inside lever 26 is: linked, via a second Bowden cable 25 (see FIG. 6), with the inside handle (illustration thereof omitted) provided on the intra-vehicle side of the door D; and rotated in association with the opening operation of the inside handle. The second Bowden cable 25 is an operation force transmitting member. The opening lever 27 is: coupled to an end portion of the outside lever 29 that moves in association with the opening operation of the outside handle (illustration thereof omitted) provided on the extra-vehicle side of the door D, the end portion on the intra-vehicle side; linked with the key lever and the locking lever 24; and movable between a locked position and an unlocked position. Components of the operation mechanism are not directly related to the present invention, and are known components incorporated in a normal door latch device, and thus their detailed description will be omitted.

As illustrated in FIG. 3, in a state where the engagement unit 2 has been installed in the body accommodating portion 21, a lower end portion of a proximal portion 193 of the second casing 192 protrudes lower than the engagement unit 2. As illustrated in FIG. 9 also, on a rear surface of the proximal portion 193, a support shaft 28 in a front-rear direction is provided in a protruding manner, integrally therewith and rearward. On the support shaft 28, an intermediate portion of the outside lever 29 directed in the indoor-outdoor direction is pivotably supported to be pivotable in the up-down direction. An end portion of the outside lever 29 protrudes more than the second casing 192, the end portion on the extra-vehicle side. The vicinity of a portion where the outside lever 29 is attached in the second casing 192, that is, a surface of the second casing 192, the surface facing, below the body 4, the inner panel D1 of the door D, is open, such that the outside lever 29 is exposed, excluding an end portion of the outside lever 29, the end portion on the intra-vehicle side.

As illustrated in FIG. 2 and FIG. 3, a bracing piece 21b adjacent to a rear surface of the outside lever 29, the rear surface on the extra-vehicle side, is provided continuously and integrally with a lower end portion of an outer peripheral wall portion 21a of the body accommodating portion 21 in the second casing 192. By sandwiching, between this bracing piece 21b and the proximal portion 193 of the second casing 192, the end portion of the outside lever 29, the end portion on the extra-vehicle side, wobbling of the outside lever 29 in the front-rear direction is prevented. The bracing piece 21b also has a function as a protective wall that prevents an unlawful means inserted in the door D from entering the operation mechanism accommodating portion 20.

As illustrated in FIG. 3, when the engagement unit 2 is installed in the body accommodating portion 21, a rear surface of the support shaft 28 and a rear surface near the intermediate portion of the outside lever 29 are covered by the lower end portion of the back plate 17 protruding below the engagement unit 2. In the lower end portion of the back plate 17, the lower end portion opposite to the support shaft 28, a female screw hole 30 is formed. By passing the bolt 18 inserted from the front surface side of the second casing 192 through the support shaft 28 and screwing the bolt 18 into this female screw hole 30, the intermediate portion of the outside lever 29 is pivotably held on opposite surfaces of the second casing 192 and the back plate 17. The end portion of the outside lever 29, the end portion on the intra-vehicle side, is coupled to the opening lever 27 via an opening 192a (see FIG. 4 and FIG. 9). The opening 192a is formed lower than the engagement unit 2 in the casing 19, and connects the operation mechanism accommodating portion 20 of the first casing 191 with the second casing 192. The opening lever 27 forms a part of the operation mechanism accommodated in the operation mechanism accommodating portion 20.

As illustrated in FIG. 2, FIG. 8, and FIG. 9, closer to a lower portion of the side surface of the body 4, the side surface on the extra-vehicle side, an engagement piece 31, which protrudes in the outdoor direction and is plate-shaped, is integrally provided therewith. Further, in a thick wall portion 211 formed on an inner surface of a side wall portion of the body accommodating portion 21 in the second casing 192, the side wall portion on the extra-vehicle side, an engagement groove 32 is formed. The engagement piece 31 is engageable with the engagement groove 32 from the intra-vehicle side when the engagement unit 2 is joined and integrated with the operation unit 3, and the engagement groove 32 is open towards the inner panel D1 of the door D (in an indoor direction). The engagement piece 31 and the engagement groove 32 form a positioning means for positioning and fixing the engagement unit 2 in the body accommodating portion 21 of the second casing 192.

As illustrated in FIG. 2 to FIG. 4 and FIG. 9, a protective wall 33 is integrally provided with an indoor-outdoor direction intermediate portion on a lower surface of the body 4. The protective wall 33 is provided downwards so as to be adjacent to a rear surface of the intermediate portion of the outside lever 29 and adjacent to the opening 192a communicating into the above described operation mechanism accommodating portion 20. The opening 192a is covered by this protective wall 33 from the extra-vehicle side. When this protective wall 33 is provided, even if, for example, from a gap between an outer panel and door glass of the door, an unlawful means, such as a special tool, is inserted towards the portion where the outside lever 29 is attached in the casing 19, the unlawful means is blocked by the protective wall 33. Accordingly, the unlawful means will not go into the operation mechanism accommodating portion 20 via the opening 192a. Therefore, the locking and unlocking means, such as the opening lever 27 accommodated in the operation mechanism accommodating portion 20, will not be moved in an unlocking direction by an unlawful means, and there will be no risk that the door will be released.

Further, since the protective wall 33 is integrally provided with the body 4, which is made of synthetic resin, as compared to a case where the protective wall 33 is provided in the back plate 17, which is made of metal, downsizing and weight reduction of the back plate 17 are able to be achieved, and downsizing and weight reduction of the door latch device 1 are also able to be achieved. What is more, as described above, since the engagement piece 31, which is the positioning means, is also integrally provided with the body 4, which is made of synthetic resin, instead of with the back plate 17, which is made of metal, the weight of the door latch device 1 is able to be reduced even more.

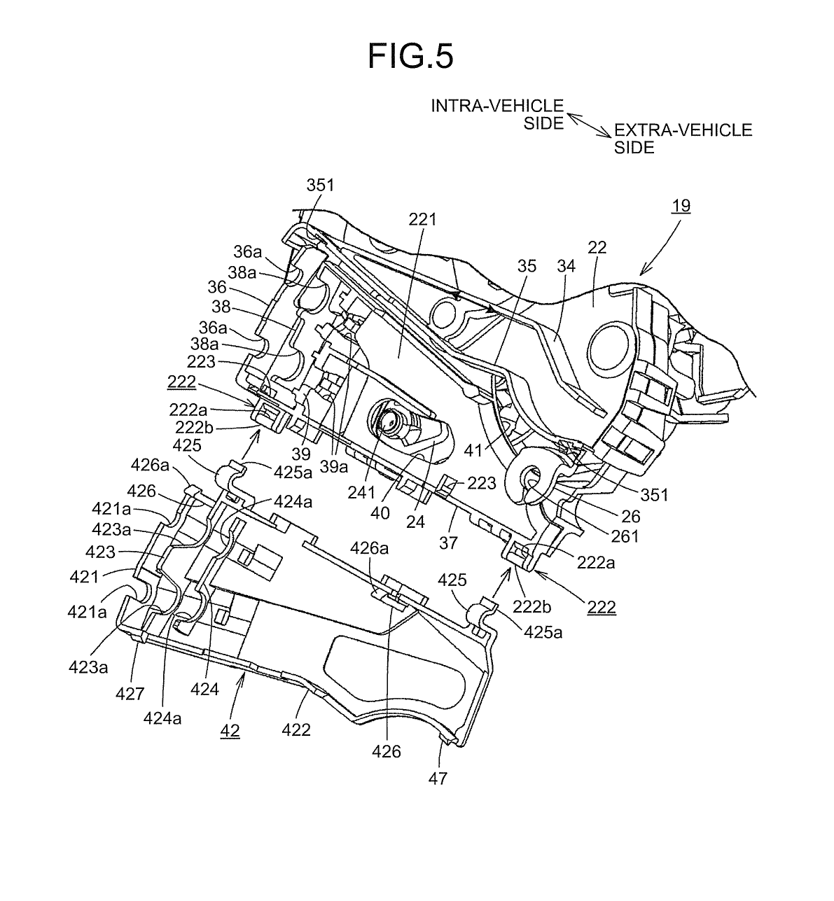

As illustrated in FIG. 5 and FIG. 6, an upper rainwater guide protruding portion 34 and a lower rainwater guide protruding portion 35, which protrude in the indoor direction, are sloped downward to the rear, and are visor-shaped, are formed in a lower portion on a side surface of the cover 22, the side surface directed to the intra-vehicle side. The upper rainwater guide protruding portion 34 and lower rainwater guide protruding portion 35 are for guiding rainwater flowing down along a surface of the cover 22 downward to the rear, and preventing the rainwater from flowing towards a later described cable coupling region portion 221.

Below the lower rainwater guide protruding portion 35 in the cover 22, the cable coupling region portion 221 is formed to be sloped downward to the rear. The cable coupling region portion 221 is for coupling the first and second Bowden cables 23 and 25 to the locking lever 24 and inside lever 26, respectively. This cable coupling region portion 221 is formed to be surrounded by: the lower rainwater guide protruding portion 35; a front wall portion 36, which is provided along a front edge of the cover 22, protrudes to the intra-vehicle side, and is in an oblique up-down direction; and a lower wall portion 37, which is provided along a lower edge of the cover 22, the lower edge sloped downward to the rear, protrudes to the intra-vehicle side, and is in the front-rear direction.

In the cable coupling region portion 221, an intermediate wall portion 38 in the up-down direction, a cable holding portion 39 in the up-down direction, a long hole 40, and a notch 41, are formed. The intermediate wall portion 38 faces the front wall portion 36 and protrudes in the indoor direction. The cable holding portion 39 faces the intermediate wall portion 38 a little rearward of the intermediate wall portion 38 and protrudes in the indoor direction. The long hole 40 is open to communicate into the operation mechanism accommodating portion 20 of the casing 19, and has a shape that is along a rotational locus of a lower end portion of the locking lever 24. The notch 41 communicates into the operation mechanism accommodating portion 20, a lower end portion of the inside lever 26 protrudes towards the cable coupling region portion 221, and the notch 41 has a shape along a rotational locus of the lower end portion of the inside lever 26. In the front wall portion 36, two fitting grooves 36a and 36a are formed, into which end portions of outer tubes 231 and 251 of the first and second Bowden cables 23 and 25 are fitted. In the intermediate wall portion 38, two fitting grooves 38a and 38a are formed, into which large diameter end portions 232 and 252 of the first and second Bowden cables 23 and 25 are fitted. Further, in the cable holding portion 39, holding grooves 39a and 39a are formed, which, by being fitted with ring shaped grooves formed at distal end portions of the large diameter end portions 232 and 252 of the first and second Bowden cables 23 and 25, hold both the large diameter end portions 232 and 252 unmovably in an axial direction.

A coupling portion 233a, which is of a terminal portion of the inner cable 233 in the first Bowden cable 23 and is spherically shaped, is fitted, via the long hole 40, in a concave portion 241, which is formed at the lower end portion of the locking lever 24, is open to the intra-vehicle side, and is hemispherically shaped. Further, a coupling portion 253a, which is of a terminal portion of an inner cable 253 in the second Bowden cable 25 and is shaft shaped, is fitted in a fitting hole 261, which is formed in the lower end portion of the inside lever 26, the lower end portion protruding from the notch 41. Both the coupling portions 233a and 253a are prevented from being separated from the concave portion 241 and the fitting hole 261, by an auxiliary cover 42 described later, which closes the cable coupling region portion 221. The concave portion 241 of the locking lever 24 and the fitting hole 261 of the inside lever 26 correspond to a coupled unit.

The cable coupling region portion 221 is closed by the auxiliary cover 42, which forms a body separate from the cover 22 and is made of synthetic resin, such as polypropylene, after the first and second Bowden cables 23 and 25 are coupled to the locking lever 24 and inside lever 26, respectively.

As illustrated in FIG. 5, the auxiliary cover 42 substantially has the same shape as the cable coupling region portion 221, and at a front edge of the auxiliary cover 42, a side wall portion 421 adjacent to a front surface of the front wall portion 36 of the cover 22 protrudes towards the cable coupling region portion 221 in a state where the cable coupling region portion 221 has been closed. Further, at a lower edge of the auxiliary cover 42, an upper wall portion 422, which is abuttable against, in a region adjacent to and below the lower rainwater guide protruding portion 35 of the cover 22, a side surface of the cover 22, the side surface on the intra-vehicle side, protrudes towards the cable coupling region portion 221 so as to be continuous with the side wall portion 421, in the state where the cable coupling region portion 221 has been closed. In the side wall portion 421, pressing grooves 421a and 421a are formed, which are able to press and hold the outer tubes 231 and 251 of the first and second Bowden cables 23 and 25 from the intra-vehicle side in the state where the cable coupling region portion 221 has been closed.

Further, in a front portion of a reverse surface (a surface that is opposite to the cable coupling region portion 221 in the state where the cable coupling region portion 221 has been closed) of the auxiliary cover 42, a first intermediate side wall portion 423 and a second intermediate side wall portion 424 respectively protrude toward the cable coupling region portion 221 in the state where the cable coupling region portion 221 has been closed, the first intermediate side wall portion 423 positioned between the front wall portion 36 and intermediate wall portion 38 of the cover 22, and the second intermediate side wall portion 424 positioned between the intermediate wall portion 38 and cable holding portion 39 of the cover 22. In the first intermediate side wall portion 423 and second intermediate side wall portion 424, upper and lower two pressing grooves 423a and upper and lower two pressing grooves 424a are respectively formed, which are able to press and hold the large diameter end portions 232 and 252 of the first and second Bowden cables 23 and 25 from the intra-vehicle side, in the state where the cable coupling region portion 221 has been closed.

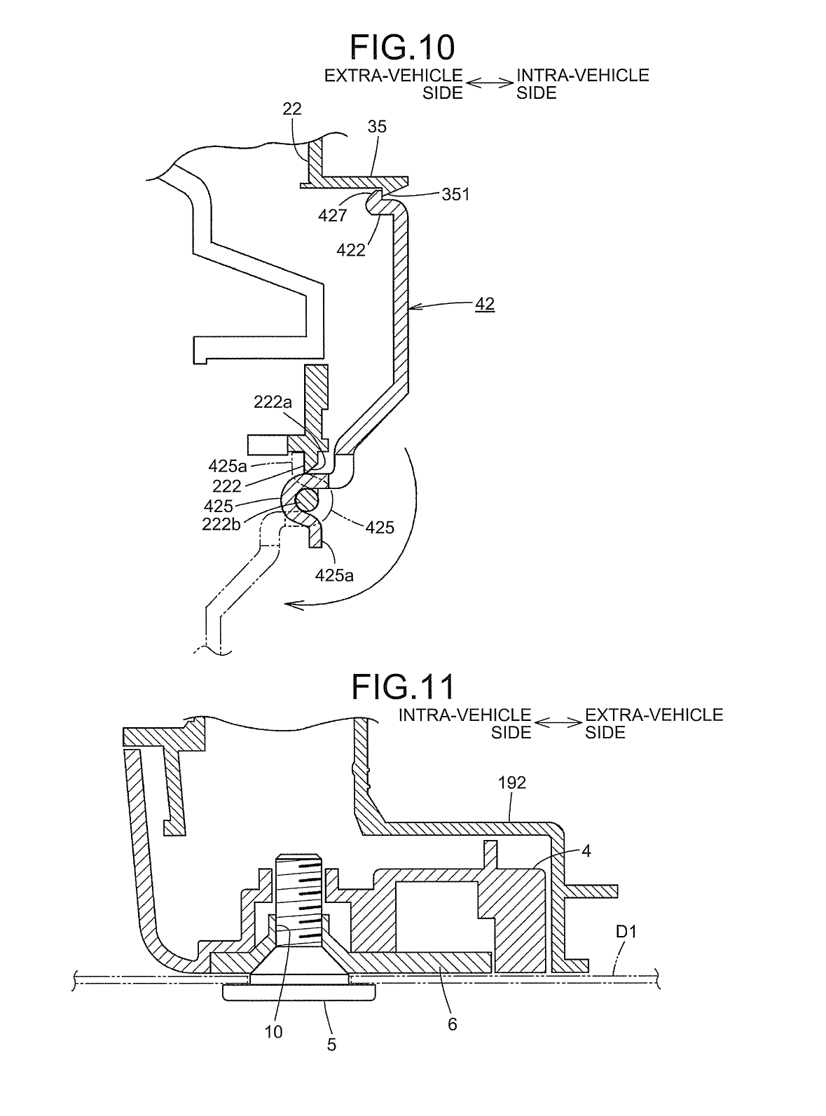

At a front portion and a rear portion of an upper edge (a lower edge in the state where the cable coupling region portion 221 has been closed) of the auxiliary cover 42, as illustrated in a cross sectional view of FIG. 10, a pair of pivotal portions 425 and 425 are integrally formed with the front portion and rear portion, the pivotal portions open in the indoor direction in the state where the cable coupling region portion 221 has been closed and having U-shaped cross sections. At free ends (distal ends) of both the pivotal portions 425, rotation restricting portions 425a are provided (details thereof described later), which are directed downward in the state where the cable coupling region portion 221 has been closed, are directed upward in a state where the cable coupling region portion 221 is open, and prevent the auxiliary cover 42 coupled to the cover 22 from rotating over an open position.

As illustrated in FIG. 5, at a front portion and a rear portion of a lower end of the cable coupling region portion 221 in the cover 22, attachment portions 222 and 222 are provided downward in a protruding manner. In both the attachment portions 222, openings 222a, into which the pivotal portions 425 of the auxiliary cover 42 are insertable, and hinge shafts 222b, which are able to pivotably support inner surfaces of U-shaped bent portions of the pivotal portions 425 to be rotatable below the openings 222a and are in the front-rear direction, are provided.

At a front end portion and a rear portion of the reverse surface adjacent to the upper edge of the auxiliary cover 42, engagement pieces 426 and 426 are provided in a protruding manner, which are directed in the outdoor direction in the state where the cable coupling region portion 221 has been closed, and which have engagement claws 426a at distal end portions thereof.

Further, on a lower surface (an upper surface in the state where the cable coupling region portion 221 has been closed) of both front and rear end portions of the upper wall portion 422 of the auxiliary cover 42, the front and rear end portions opposite to the pivotal portions 425 and 425, engagement claw portions 427 and 427 are provided in a protruding manner (see FIG. 10).

Both of the above described engagement pieces 426 are fitted into engagement holes 223 and 223 provided in a front end portion and a rear portion of the cable coupling region portion 221 in the cover 22 when the cable coupling region portion 221 is closed by the auxiliary cover 42, and the engagement claws 426a of both the engagement pieces 426 engage with opening edges of deep ends of the engagement holes 223 and 223.

Further, as illustrated in FIG. 10, both of the above described engagement claw portions 427 engage with engaged claw portions 351 provided in both front and rear end portions of a lower surface of the lower rainwater guide protruding portion 35 in the cover 22 when the cable coupling region portion 221 is closed by the auxiliary cover 42. By these front and rear two engagement claws 426a and front and rear two engagement claw portions 427, four places of the auxiliary cover 42 are stably fixed, without wobbling, to the cable coupling region portion 221 of the cover 22.

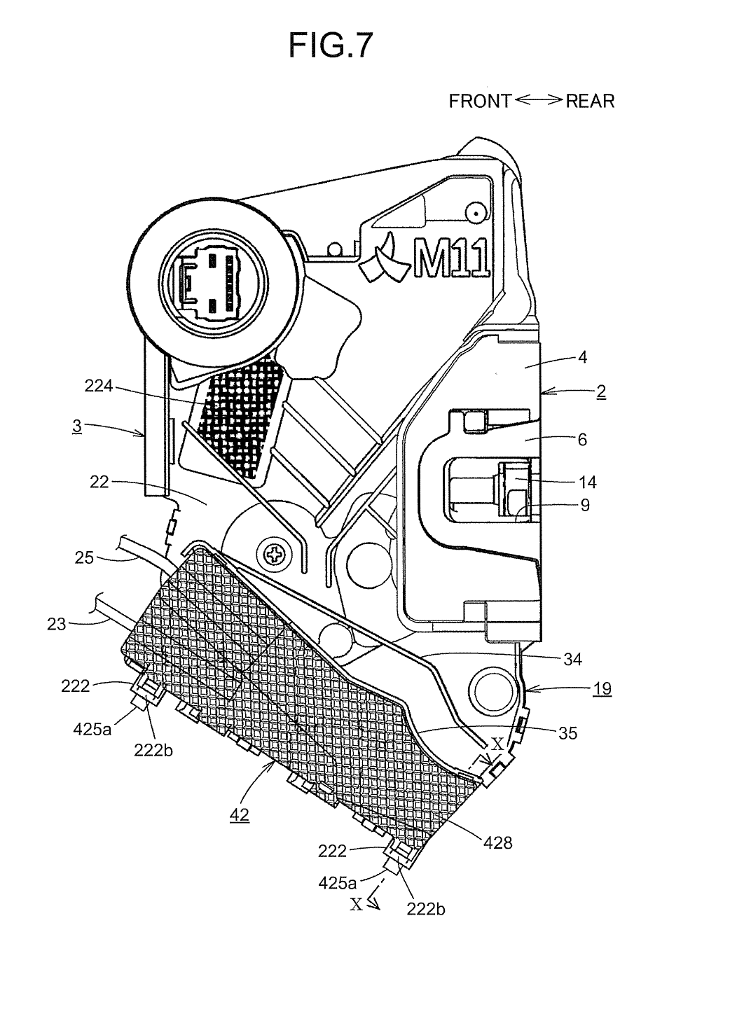

As illustrated in FIG. 7, on a surface (a side surface on the intra-vehicle side in the state where the cable coupling region portion 221 has been closed) of the auxiliary cover 42, meshed protruding strips 428 for preventing slippage are formed; and when the door latch device 1 is installed in the door D, by a portion where the protruding strips 224 of the cover 22 are formed, a portion where the protruding strips 428 of the auxiliary cover 42 are formed, and a portion where the protruding strips 201 of the operation mechanism accommodating portion 20 in the first casing 191 are formed being held by a hand, the door latch device 1 is able to be efficiently installed in the door D while slippage is prevented.

In order to attach the auxiliary cover 42 to the cover 22, the whole auxiliary cover 42 is rotated downward while the rotation restricting portions 425a of both the pivotal portions 425 provided in the auxiliary cover 42 are inserted, in a direction substantially orthogonal to a surface of the cover 22, into the openings 222a provided in both the attachment portions 222 of the cover 22, the surface on the intra-vehicle side, to fit inner peripheral surfaces of the pivotal portions 425 to the hinge shafts 222b of the attachment portions 222. Thereby, as illustrated in FIG. 6 and FIG. 10, the auxiliary cover 42 is pivotably supported by the respective attachment portions 222 of the lower end of the cable coupling region portion 221, to be rotatable in the up-down direction about the hinge shafts 222b to the open position (two dot chain lined position in FIG. 10) where the cable coupling region portion 221 is open and to a closed position (solid lined position in FIG. 10) where the cable coupling region portion 221 is closed.

When the auxiliary cover 42 is in the open position, by the rotation restricting portions 425a of distal end portions of the respective pivotal portions 425 abutting against surfaces of proximal end portions of the attachment portions 222, the surfaces on the extra-vehicle side, as illustrated with the two dot chain line in FIG. 10, the auxiliary cover 42 is prevented from rotating in the outdoor direction over the open position. Thereby, the auxiliary cover 42 is held in the open position, and thus, the auxiliary cover 42 is less likely to rotate indiscriminately and be obstructive when the first and second Bowden cables 23 and 25 are installed in the cable coupling region portion 221, or the inner cables 233 and 253 thereof are coupled to the locking lever 24 and inside lever 26.

When the auxiliary cover 42 is rotated to the closed position after the first and second Bowden cables 23 and 25 have been installed in the cable coupling region portion 221 and the inner cables 233 and 253 have been coupled to the locking lever 24 and inside lever 26, the engagement pieces 426 and engagement claw portions 427 of the auxiliary cover 42 engage with the engagement holes 223 and engaged claw portions 351 at the cover 22 side respectively, and the auxiliary cover 42 is held in the closed position (see FIG. 7 and FIG. 10). Thereby, the cable coupling region portion 221 is covered by the auxiliary cover 42, and rainwater is prevented from entering the cable coupling region portion 221. Further, the front, rear, upper, and lower four places of the auxiliary cover 42 are stably fixed to the cable coupling region portion 221 of the cover 22, and thus wobbling of the auxiliary cover 42 is prevented. Since, in the state where the cable coupling region portion 221 has been closed by the auxiliary cover 42, the upper of the auxiliary cover 42 is covered by the visor shaped upper rainwater guide protruding portion 34 and lower rainwater guide protruding portion 35 of upper and lower two strips that guide rainwater flowing down along the surface of the cover 22 downward to the rear, the rainwater is even less likely to enter the cable coupling region portion 221.

As described above, in the above described door latch device according to the embodiment, the female screw holes 10a, 10b, and 10c, into which the bolts 5 for fixing to the inner panel D1 of the door D are screwed, are provided in the cover plate 6, thereby achieving downsizing and weight reduction of the whole door latch device 1 including the back plate 17, as compared to a conventional door latch device having female screw holes provided in the back plate 17.

Further, since the upper and lower positioning holes 11 and 12 provided in the cover plate 6 are largely separated from the outer bent portion 6b of the cover plate 6, there will be no risk that the positioning holes 11 and 12 will be deformed when the outer bent portion 6b is bent by press working after the positioning holes 11 and 12 are drilled and that projecting portions of a positioning tool will be uninsertable thereinto.

Furthermore, since the upper positioning hole 11 is a long hole, which is long in the direction of the straight line joining the centers of the upper and lower positioning holes 11 and 12, there will be no risk that the cover plate 6 will rotate about the lower positioning hole 12 and be displaced when the projecting portions of the positioning tool are inserted in the upper and lower positioning holes 11 and 12, and insertion and removal of the projecting portion of the positioning tool into and from the upper positioning hole 11 will become easy. Moreover, since the minor axis direction dimension of the upper positioning hole 11 which forms the long hole is the same as the diameter of the lower positioning hole 12, outer diameters of two projecting portions of a positioning tool are able to be made the same. Therefore, there will be no need to check every time the positional relation between the two projecting portions of the positioning tool and the upper and lower positioning holes 11 and 12, and thus positioning work of the cover plate 6 by the positioning tool will become easy.

### REFERENCE SIGNS LIST

1 DOOR LATCH DEVICE
2 ENGAGEMENT UNIT
3 OPERATION UNIT
4 BODY
5 BOLT
6 COVER PLATE
6a INNER BENT PORTION
6b OUTER BENT PORTION
7 STRIKER
8 ENGAGEMENT MECHANISM
9 STRIKER ADVANCING GROOVE
10a, 10b, 10c FEMALE SCREW HOLE
11 POSITIONING HOLE THAT IS LONG
12 POSITIONING HOLE THAT IS CIRCULAR
13 PIVOT SHAFT
14 LATCH
15 PIVOT SHAFT
16 RATCHET
17 BACK PLATE
18 BOLT
19 CASING
20 OPERATION MECHANISM ACCOMMODATING PORTION
21 BODY ACCOMMODATING PORTION
21a OUTER PERIPHERAL WALL PORTION
21b BRACING PIECE
22 COVER
23 FIRST BOWDEN CABLE
24 LOCKING LEVER
25 SECOND BOWDEN CABLE
26 INSIDE LEVER
27 OPENING LEVER
28 SUPPORT SHAFT
29 OUTSIDE LEVER
30 FEMALE SCREW HOLE
31 ENGAGEMENT PIECE
32 ENGAGEMENT GROOVE
33 PROTECTIVE WALL
34 UPPER RAINWATER GUIDE PROTRUDING PORTION
35 LOWER RAINWATER GUIDE PROTRUDING PORTION
36 FRONT WALL PORTION
36a FITTING GROOVE
37 LOWER WALL PORTION
38 INTERMEDIATE WALL PORTION
38a FITTING GROOVE
39 CABLE HOLDING PORTION
39a HOLDING GROOVE
40 LONG HOLE
41 NOTCH
42 AUXILIARY COVER
191 FIRST CASING
192 SECOND CASING
192a OPENING
193 PROXIMAL PORTION
201 PROTRUDING STRIP
211 THICK WALL PORTION
221 CABLE COUPLING REGION PORTION
222 ATTACHMENT PORTION
222a OPENING
222b HINGE SHAFT
223 ENGAGEMENT HOLE
224 PROTRUDING STRIP
231, 251 OUTER TUBE
232, 252 LARGE DIAMETER END PORTION
233, 253 INNER CABLE
233a, 253a COUPLING PORTION
241 CONCAVE PORTION
261 FITTING HOLE
351 ENGAGED CLAW PORTION
421 SIDE WALL PORTION
421a PRESSING GROOVE
422 UPPER WALL PORTION
423 FIRST INTERMEDIATE SIDE WALL PORTION
424 SECOND INTERMEDIATE SIDE WALL PORTION
423a, 424a PRESSING GROOVE
425 PIVOTAL PORTION
425a ROTATION RESTRICTING PORTION
426 ENGAGEMENT PIECE
426a ENGAGEMENT CLAW
427 ENGAGEMENT CLAW PORTION
428 PROTRUDING STRIP
D DOOR
D1 INNER PANEL

1. A vehicle door latch device, comprising:
a body configured to accommodate therein an engagement mechanism adapted to restrain a door in a closed position, the body including
a striker advancing groove, into which a striker is able to advance;
a cover plate made of metal and configured to close a surface of the body, the cover plate including:
a striker advancing groove having a shape that is substantially the same as a shape of the striker advancing groove of the body; and
a bent portion at a side portion opposite to an inlet of the striker advancing groove and bent substantially perpendicularly towards the body;
at least one female screw hole, into which a bolt for fixing the door is screwable, provided closer to a side end portion of the cover plate, the side end portion opposite to the bent portion, at any one of both sides sandwiching the striker advancing groove in the cover plate;
at least two female screw holes, into which bolts for fixing the door are screwable, provided separately from each other in a direction in which the striker advances, at the other one of the both sides sandwiching the same striker advancing groove; and
positioning holes, for positioning the cover plate when various parts of the engagement mechanism are installed in the cover plate, respectively provided near the one female screw hole and between the two female screw holes in the cover plate.

2. The vehicle door latch device according to claim 1, wherein any one of the positioning holes is a circular hole, and the other one thereof is a long hole that is long in a direction of a straight line joining centers of the positioning holes.

3. The vehicle door latch device according to claim 2, wherein a minor axis direction dimension of the positioning hole that is the long hole is the same as a diameter of the circular hole.
